(19) United States
(12) Patent Application Publication
(10) Pub. No.: US 2023/0294561 A1
(43) Pub. Date: Sep. 21, 2023

(54) Vehicle Occupancy Alarm Assembly

(71) Applicant: Celeste Crenshaw, Hayneville, AL (US)

(72) Inventor: Celeste Crenshaw, Hayneville, AL (US)

(21) Appl. No.: 17/696,974

(22) Filed: Mar. 17, 2022

(51) Int. Cl. B60N 2/00; G08B 21/02

(52) U.S. Cl. CPC B60N 2/002; G08B 21/02

(57) ABSTRACT

A vehicle occupancy alarm assembly includes a seat mounted within a vehicle which is occupied by a passenger in the vehicle. A weight sensor is integrated into the seat to sense the weight of an occupant in the seat. A door sensor is integrated into a driver's side door of the vehicle for sensing when the driver's side door is closed and when the driver's side door is opened. An alarm unit is integrated into the vehicle and the alarm unit emits a first audible alert when the ignition system is turned off and the weight sensor senses weight and the door sensor senses that the driver's side door is opened. The alarm unit emits a second audible alert when the ignition system is turned off and the weight sensor senses weight and the door sensor senses that the driver's side door is closed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to occupancy alarm devices and more particularly pertains to a new occupancy alarm device for inhibiting an occupant from being left unattended in a vehicle. The device includes a door sensor which senses if a driver's side door is opened or closed and a weight sensor in a rear seat of the vehicle which senses weigh of an occupant. The device includes an alarm unit which emits a first alert when the driver's side door is opened, an ignition of the vehicle is turned off and the weight sensor senses weight. The alarm unit emits a second alert when the driver's side door is closed, the ignition of the vehicle is turned off and the weight sensor senses weight

### (2) Description of Related Art Including Information Disclosed Under 37 CFR 1.97 and 1.98

The prior art relates to occupancy alarm devices including a pressure sensor integrated into a vehicle seat, a plastic covering the pressure sensor and a speaker that is attached to the vehicle seat. The prior discloses a child car seat which includes a pressure sensor attached to the child car seat and a speaker coupled to the child car seat. The prior art discloses a vehicle occupancy alert that includes a pair of door sensors each integrated into a respective driver's door and passenger's door and alert flag which is actuated according to a predetermined combination of the driver's door and passenger's door being opened. The prior art discloses a vehicle occupancy alert that includes a sensing unit that is positionable beneath a child car seat and an alert unit that is positionable in a vehicle which emits an audible alert with a driver's door is opened and the sensing unit senses weight. The prior art discloses a vehicle occupancy alert which includes a fuel flow sensor, a seat sensor and an alarm which emits an audible alert when the fuel flow sensor senses fuel flowing in the vehicle and the seat sensor senses weight.

### BRIEF SUMMARY OF THE INVENTION

An embodiment of the disclosure meets the needs presented above by generally comprising a seat mounted within a vehicle which is occupied by a passenger in the vehicle. A weight sensor is integrated into the seat to sense the weight of an occupant in the seat. A door sensor is integrated into a driver's side door of the vehicle for sensing when the driver's side door is closed and when the driver's side door is opened. An alarm unit is integrated into the vehicle and the alarm unit emits a first audible alert when the ignition system is turned off and the weight sensor senses weight and the door sensor senses that the driver's side door is opened. The alarm unit emits a second audible alert when the ignition system is turned off and the weight sensor senses weight and the door sensor senses that the driver's side door is closed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective phantom view of a vehicle occupancy alarm assembly according to an embodiment of the disclosure showing a driver's side door being closed.

FIG. 2 is a perspective phantom view of an embodiment of the disclosure showing a driver's side door being opened.

FIG. 3 is a left side perspective view of an embodiment of the disclosure showing a sedan.

FIG. 4 is a left side perspective view of an embodiment of the disclosure showing a sport utility vehicle.

FIG. 5 is a logic tree view of an embodiment of the disclosure.

FIG. 6 is a schematic view of an embodiment of the disclosure.

### DETAILED DESCRIPTION OF THE INVENTION

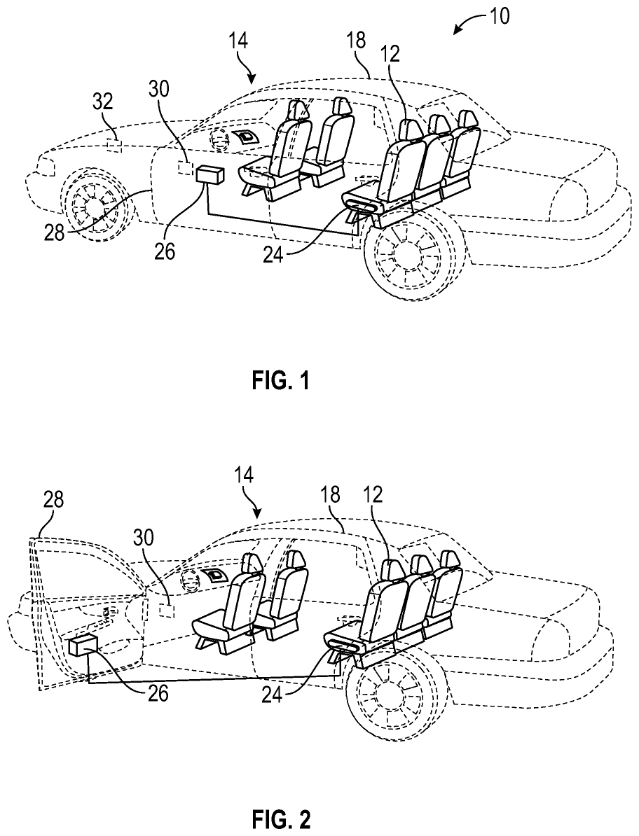

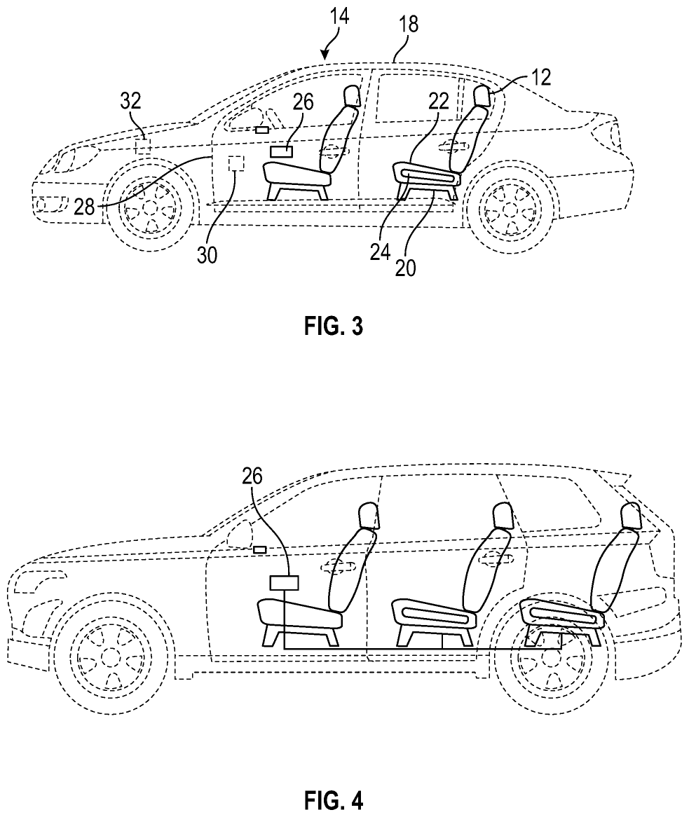

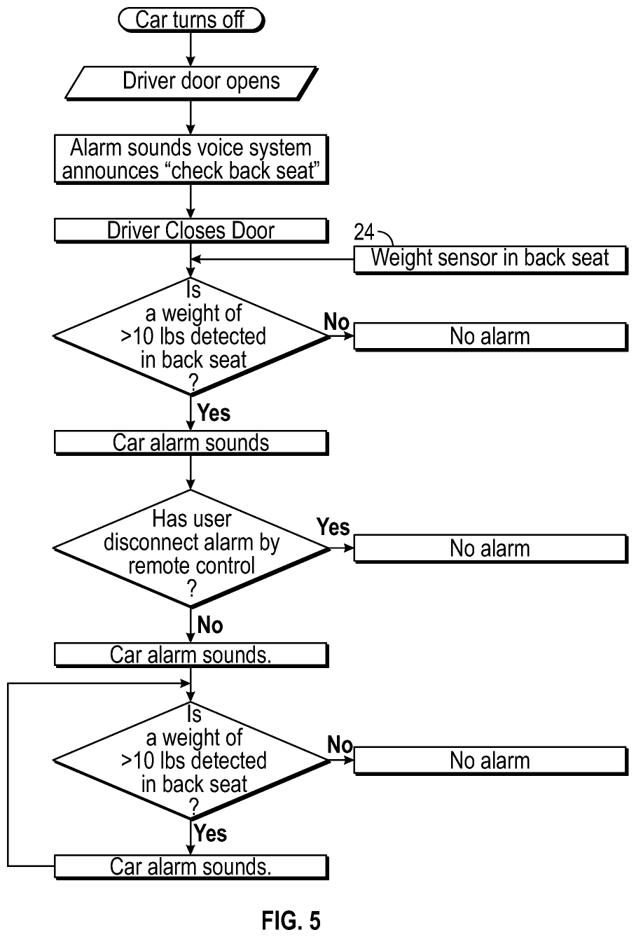

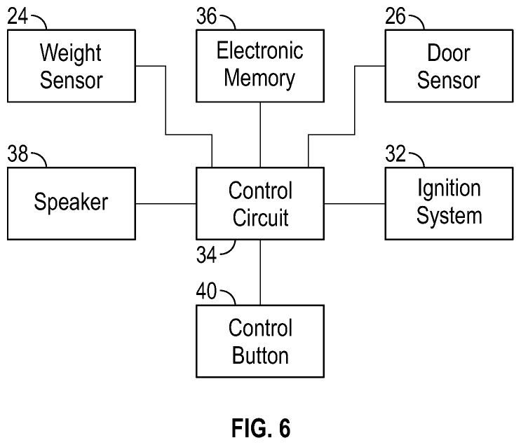

With reference now to the drawings, and in particular to FIGS. 1 through 6 thereof, a new occupancy alarm device embodying the principles and concepts of an embodiment of the disclosure and generally designated by the reference numeral 10 will be described.

As best illustrated in FIGS. 1 through 6, the vehicle occupancy alarm assembly generally comprises a seat 12 that is mounted within a vehicle 14 such that the seat 12 can be occupied by a passenger in the vehicle 14. The seat 12 is positioned in a rear portion 16 of a cabin 18 of the vehicle 14 and the seat 12 has a lower surface 20 and an upper surface 22. The vehicle 14 may be a passenger vehicle, a cargo vehicle or any other motorized vehicle that is driven on public roadways. Furthermore, the vehicle 14 may be a sedan, a sport utility vehicle or any other type of vehicle that has a least one row of back seats.

A weight sensor 24 is integrated into the seat 12 to sense the weight of an occupant in the seat 12. The weight sensor 24 is positioned between the lower surface 20 and the upper surface 22 of the seat 12. Additionally, the weight sensor 24 may comprise an electronic weight sensor that has a trigger weight of approximately 10.0 pounds. A door sensor 26 is integrated into a driver's side door 28 of the vehicle 14. The door sensor 26 is actuated into a first condition when the driver's side door 28 is closed. Furthermore, the door sensor 26 is actuated into a second condition when the driver's side door 28 is opened. The door sensor 26 may comprise an electronic door switch or the like and the door sensor 26 may be standard equipment of the vehicle 14 that is installed during the factory manufacturing process.

An alarm unit 30 is integrated into the vehicle 14 and the alarm unit 30 is in communication with the weight sensor 24 and the door sensor 26. Additionally, the alarm unit 30 is in communication with an ignition system 32 of the vehicle 14. The alarm unit 30 emits a first audible alert when the ignition system 32 is turned off and the weight sensor 24 senses weight and the door sensor 26 senses that the driver's side door 28 is opened. Furthermore, the alarm unit 30 emits a second audible alert when the ignition system 32 is turned off and the weight sensor 24 senses weight and the door sensor 26 senses that the driver's side door 28 is closed.

The alarm unit 30 comprises a control circuit 34 that is integrated in the vehicle 14 and the control circuit 34 is electrically coupled to the ignition system 32 of the vehicle 14. The control circuit 34 is electrically coupled to the door sensor 26 and the control circuit 34 is electrically coupled to the weight sensor 24. The control circuit 34 receives a first alert input when the ignition system 32 is turned off and the weight sensor 24 senses weight and the door sensor 26 is actuated into the first condition. Moreover, the control circuit 34 receives a second alert input when the ignition system 32 is turned off and the weight sensor 24 senses weight and the door sensor 26 is actuated into the second condition. The control circuit 34 is restricted from receiving the second alert input until after the control circuit 34 receives the first alert input.

The alarm unit 30 includes an electronic memory 36 that is integrated into the control circuit 34. The electronic memory 36 stores a database comprising a first audible alert and a second audible alert. The first audible alert comprises a repeating sequence of alarm tones which have a minimum intensity and a verbal phrase. The alarm tones may be a bell chime and the verbal phrase may comprise the words “check the backseat 12”. The second audible alert comprises a repeating sequence of alarm tones which have a maximum intensity. The alarm tones associated with the second audible alert may a bell chime of a different pitch than the bell chime associated with the first audible alert or any other sound that implies a heightened sense of urgency compared to the alarm tones associated with the first audible alert.

The alarm unit 30 includes a speaker 38 which is integrated into the vehicle 14 to emit audible sounds into the cabin 18 of the vehicle 14. The speaker 38 is electrically coupled to the control circuit 34 and the speaker 38 receives the first audible alert from the electronic memory 36 when the control circuit 34 receives the first alert input. Furthermore, the speaker 38 receives the second audible alert from the electronic memory 36 when the control circuit 34 receives the second alert input. A control button 40 is integrated into a dashboard 42 of the vehicle 14 such that the control button 40 is accessible to the driver of the vehicle 14. The control button 40 is in communication with the alarm unit 30, the control button 40 de-actuates the alarm unit 30 when the control button 40 is depressed and the control button 40 is electrically coupled to the control circuit 34.

In use, the speaker 38 emits the first audible alert when the driver turns off the ignition and the weight sensor 24 senses weight and the driver opens the driver's side door 28. In this way the driver is notified that the occupant remains seated in the vehicle 14 to inhibit the occupant from being left unattended. Furthermore the first audible alert continues for at least 6.0 seconds. The speaker 38 emits the second audible alert when the driver closes the driver's side door 28 and the weight sensor 24 senses weight. In this way the alarm unit 30 increases the intensity of the alert to communicate that the driver is taking action that will result in the occupant being left unattended in the vehicle 14. The driver can actuate the control button 40 to turn off the alarm unit 30 when the occupant is an adult that can care for themselves and is capable of exiting the vehicle 14 without assistance.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle occupancy alarm assembly for alerting a driver that an occupant remains in a vehicle when the vehicle is turned off, said assembly comprising:
a seat being mounted within a vehicle wherein said seat is configured to be occupied by a passenger in the vehicle;
a weight sensor being integrated into said seat wherein said weight sensor is configured to sense the weight of an occupant in said seat;
a door sensor being integrated into a driver's side door of the vehicle, said door sensor being actuated into a first condition when the driver's side door is opened, said door sensor being actuated into a second condition when the driver's side door is closed;
an alarm unit being integrated into the vehicle, said alarm unit being in communication with said weight sensor and said door sensor, said alarm unit being in communication with an ignition system of the vehicle, said alarm unit emitting a first audible alert when the ignition system is turned off and said weight sensor senses weight and said door sensor senses that the driver's side door is opened, said alarm unit emitting a second audible alert when the ignition system is turned off and said weight sensor senses weight and said door sensor senses that the driver's side door is closed; and
a control button being integrated into a dashboard of the vehicle wherein said control button is configured to be accessible to the driver of the vehicle, said control button being in communication with said alarm unit, said control button de-actuating said alarm unit when said control button is depressed.

2. The assembly according to claim 1, wherein:
said seat is positioned in a rear portion of a cabin of the vehicle, said seat having a lower surface and an upper surface; and
said weight sensor being positioned between said lower surface and said upper surface of said seat.

3. The assembly according to claim 1, wherein said alarm unit comprises a control circuit being integrated in the vehicle, said control circuit being electrically coupled to the ignition system of the vehicle, said control circuit being electrically coupled to said door sensor, said control circuit being electrically coupled to said weight sensor, said control circuit receiving a first alert input when the ignition system is turned off and said weight sensor senses weight and said door sensor is actuated into said first condition, said control circuit receiving a second alert input when the ignition system is turned off and said weight sensor senses weight and said door sensor is actuated into said second condition, said control circuit being restricted from receiving said second alert input until after said control circuit receives said first alert input.

4. The assembly according to claim 3, wherein said alarm unit includes an electronic memory being integrated into said control circuit, said electronic memory storing a database comprising a first audible alert and a second audible alert, said first audible alert comprising a repeating sequence of alarm tones having a minimum intensity and a verbal phrase, said second audible alert comprising a repeating sequence of alarm tones having a maximum intensity.

5. The assembly according to claim 4, wherein said alarm unit includes a speaker being integrated into the vehicle wherein said speaker is configured to emit audible sounds into the cabin of the vehicle, said speaker being electrically coupled to said control circuit, said speaker receiving said first audible alert from said electronic memory when said control circuit receives said first alert input, said speaker receiving said second audible alert from said electronic memory when said control circuit receives said second alert input.

6. A vehicle occupancy alarm assembly for alerting a driver that an occupant remains in a vehicle when the vehicle is turned off, said assembly comprising:
a seat being mounted within a vehicle wherein said seat is configured to be occupied by a passenger in the vehicle, said seat being positioned in a rear portion of a cabin of the vehicle, said seat having a lower surface and an upper surface;
a weight sensor being integrated into said seat wherein said weight sensor is configured to sense the weight of an occupant in said seat, said weight sensor being positioned between said lower surface and said upper surface of said seat;
a door sensor being integrated into a driver's side door of the vehicle, said door sensor being actuated into a first condition when the driver's side door is opened, said door sensor being actuated into a second condition when the driver's side door is closed;
an alarm unit being integrated into the vehicle, said alarm unit being in communication with said weight sensor and said door sensor, said alarm unit being in communication with an ignition system of the vehicle, said alarm unit emitting a first audible alert when the ignition system is turned off and said weight sensor senses weight and said door sensor senses that the driver's side door is opened, said alarm unit emitting a second audible alert when the ignition system is turned off and said weight sensor senses weight and said door sensor senses that the driver's side door is closed, said alarm unit comprising:
a control circuit being integrated in the vehicle, said control circuit being electrically coupled to the ignition system of the vehicle, said control circuit being electrically coupled to said door sensor, said control circuit being electrically coupled to said weight sensor, said control circuit receiving a first alert input when the ignition system is turned off and said weight sensor senses weight and said door sensor is actuated into said first condition, said control circuit receiving a second alert input when the ignition system is turned off and said weight sensor senses weight and said door sensor is actuated into said second condition, said control circuit being restricted from receiving said second alert input until after said control circuit receives said first alert input;
an electronic memory being integrated into said control circuit, said electronic memory storing a database comprising a first audible alert and a second audible alert, said first audible alert comprising a repeating sequence of alarm tones having a minimum intensity and a verbal phrase, said second audible alert comprising a repeating sequence of alarm tones having a maximum intensity; and
a speaker being integrated into the vehicle wherein said speaker is configured to emit audible sounds into the cabin of the vehicle, said speaker being electrically coupled to said control circuit, said speaker receiving said first audible alert from said electronic memory when said control circuit receives said first alert input, said speaker receiving said second audible alert from said electronic memory when said control circuit receives said second alert input; and
a control button being integrated into a dashboard of the vehicle wherein said control button is configured to be accessible to the driver of the vehicle, said control button being in communication with said alarm unit, said control button de-actuating said alarm unit when said control button is depressed, said control button being electrically coupled to said control circuit.

7. A vehicle occupancy alarm system for alerting a driver that an occupant remains in a vehicle when the vehicle is turned off, said system comprising:
a vehicle having a cabin, a passenger seat, a driver's side door and an ignition system;
a seat being mounted within said cabin of said vehicle wherein said seat is configured to be occupied by a passenger in said vehicle, said seat being positioned in a rear portion of said cabin of said vehicle, said seat having a lower surface and an upper surface;
a weight sensor being integrated into said seat wherein said weight sensor is configured to sense the weight of an occupant in said seat, said weight sensor being positioned between said lower surface and said upper surface of said seat;
a door sensor being integrated into said driver's side door of said vehicle, said door sensor being actuated into a first condition when said driver's side door is opened, said door sensor being actuated into a second condition when said driver's side door is closed;
an alarm unit being integrated into said vehicle, said alarm unit being in communication with said weight sensor and said door sensor, said alarm unit being in communication with said ignition system of said vehicle, said alarm unit emitting a first audible alert when said ignition system is turned off and said weight sensor senses weight and said door sensor senses that said driver's side door is opened, said alarm unit emitting a second audible alert when said weight sensor senses weight and said door sensor senses that said driver's side door is closed, said alarm unit comprising:
a control circuit being integrated in said vehicle, said control circuit being electrically coupled to said ignition system of said vehicle, said control circuit being electrically coupled to said door sensor, said control circuit being electrically coupled to said weight sensor, said control circuit receiving a first alert input when said ignition system is turned off and said weight sensor senses weight and said door sensor is actuated into said first condition, said control circuit receiving a second alert input when said ignition system is turned off and said weight sensor senses weight and said door sensor is actuated into said second condition, said control circuit being restricted from receiving said second alert input until after said control circuit receives said first alert input;
an electronic memory being integrated into said control circuit, said electronic memory storing a database comprising a first audible alert and a second audible alert, said first audible alert comprising a repeating sequence of alarm tones having a minimum intensity and a verbal phrase, said second audible alert comprising a repeating sequence of alarm tones having a maximum intensity; and
a speaker being integrated into said vehicle wherein said speaker is configured to emit audible sounds into said cabin of said vehicle, said speaker being electrically coupled to said control circuit, said speaker receiving said first audible alert from said electronic memory when said control circuit receives said first alert input, said speaker receiving said second audible alert from said electronic memory when said control circuit receives said second alert input; and
a control button being integrated into a dashboard of said vehicle wherein said control button is configured to be accessible to the driver of said vehicle, said control button being in communication with said alarm unit, said control button de-actuating said alarm unit when said control button is depressed, said control button being electrically coupled to said control circuit.
